(19) United States
(12) Patent Application Publication
(10) Pub. No.: US 2018/0207872 A1
(43) Pub. Date: Jul. 26, 2018

(54) Powder Recoater for Three-Dimensional Printer

(71) Applicant: The ExOne Company, North Huntingdon, PA (US)

(72) Inventors: Andrew P. Klein, Pittsburgh, PA (US); Daniel T. Brunermer, Leechburg, PA (US); Michael J. McCoy, Murrysville, PA (US); Anthony S. Dugan, McKeesport, PA (US); Lawrence J. Voss, Pittsburgh, PA (US); Thomas Lizzi, Allison Park, PA (US)

(21) Appl. No.: 15/570,395

(22) PCT Filed: Apr. 28, 2016
(86) PCT No.: PCT/US2016/029757

§ 371 Date: Feb. 16, 2018

Related U.S. Application Data
(60) Provisional application No. 62/162,980, filed on May 18, 2015.
(60) Provisional application No. 62/155,155, filed on Apr. 30, 2015.

(51) Int. Cl. B29C 64/321; B29C 64/153; B29C 64/255; B65H 5/02; B22F 3/105

(52) U.S. Cl. CPC B29C 64/321; B29C 64/153; B33Y 40/00; B65H 5/021; B22F 3/1055; B29C 64/255

(57) ABSTRACT

A device for applying powder layers across a substrate or atop an existing powder bed is disclosed. The device has particular utility in embodiments which are adapted for use in depositing powder layers for three-dimensional printing and as part of a three-dimensional printing apparatus. The device utilizes a conveyor belt to transfer powder from a powder reservoir and deposit it upon powder bed or other substrate. In some embodiments, the device utilizes a conveyor belt in conjunction with a powder deflector to transfer powder from a powder reservoir and deposit it upon powder bed or other substrate. In some embodiments the conveyor belt has a downwardly inclined section. In some embodiments, a downwardly inclined chute is used in conjunction with the conveyor belt.

### BACKGROUND

### Field of the Invention

The present invention relates to a device for applying powder layers across a substrate or atop an existing powder bed. The device has particular utility in embodiments which are adapted for use in depositing powder layers for three-dimensional printing and as part of a three-dimensional printing apparatus.

### Background of the Art

There are today various types of three-dimensional printers, i.e. devices that convert electronic representations of three-dimensional articles into the articles themselves by the systematic building-up of one or more materials. The device of the present invention finds particular utility with the types of three-dimensional printers which create three-dimensional articles by selectively binding together preselected areas of successively deposited layers of powder. These types of three-dimensional printers are referred to herein as “powder-layer three-dimensional printers” because the construction of the three-dimensional article by such printers utilizes layers of powders as a build material. Examples of such types of powder-based three-dimensional printers include, without limitation, the binder-jet three-dimensional printers, the selective sintering three-dimensional printers, and the electron beam melting three-dimensional printers.

It is to be understood that the term “powder” is also sometimes referred to in the art as “particulate material” or “particles” and the term “powder” is to be construed herein as meaning any such material, by whatever name, that is used in such three-dimensional printers as a layer-forming material. Powder may comprise any type of material capable of taking on the powder form, e.g. metal, plastics, ceramics, carbon, graphite, composite materials, minerals, etc., and combinations thereof. The term “build powder” is used herein to refer to a powder which is used to form the powder layers and from which the article is built in a powder-layer three-dimensional printer.

During the operation of a powder-layer three-dimensional printer, a first layer of a build powder is deposited upon a vertically indexible build platform and then successive powder layers are deposited one at a time upon the first powder layer. Selected portions of selected powder layers are treated to bind the powders in those portions together as the three-dimensional article is formed. Collectively, the portions of the deposited powder layers which are not bound together are referred to herein as a “powder bed.”

In some powder-layer three-dimensional printers, each powder layer is formed by transferring a predetermined quantity of build powder from an open-top stationary powder reservoir by first indexing upward a platform which supports the powder within the reservoir a predetermined amount to raise the predetermined quantity above the reservoir walls and then pushing that quantity of powder across the top of the build platform or the powder bed to form a powder layer. In some powder-layer three-dimensional printers, each powder layer is deposited upon the build platform or the extant powder bed by a traveling powder dispenser, which may or may not include some device which is adapted to level the top of the powder layer.

The process of forming a powder layer is sometimes referred to in the art, and is referred to herein, as “recoating.” The device or combination of devices of a particular powder-layer three-dimensional printer that accomplishes the recoating is sometimes referred to in the art, and is referred to herein, as a “recoater.”

Although the recoaters existing in the art today generally work well for their intended purposes, there is still a need in the art to develop recoaters which consistently provide good powder layer uniformity. The present invention makes such an improvement.

Furthermore, when fine powders are used to make the powder layers, a problem with conventional recoaters is that a plume of fine powders may arise in the vicinity of the powder bed or other substrate during the deposition of the powder from the recoater. Some of the embodiments of the present invention ameliorate or eliminate this pluming problem.

### SUMMARY OF THE INVENTION

The present invention provides a device for applying powder layers across a substrate or atop an existing powder bed. The device has particular utility in embodiments which are adapted for use in depositing powder layers for three-dimensional printing and as part of a three-dimensional printing apparatus. The device is sometimes hereinafter referred to as “inventive recoater” or, where the context is clear that the inventive recoater is meant, sometimes simply as “recoater.”

The inventive recoater comprises a carriage adapted to move across a substrate or an existing powder bed. The inventive recoater also comprises a powder reservoir for containing a desired amount of powder. The powder reservoir has one or more first openings at or near its top for receiving powder and one or more second openings at or near its bottom for dispensing powder. The inventive recoater also comprises a conveyor belt in operative communication with the one or more of the second openings of the powder reservoir and adapted to convey powder from the powder reservoir and to dispense the conveyed powder as a powder curtain. The term “operative communication” in this context means that the conveyor belt is adapted to receive powder from one or more of the second openings.

In some embodiments, the inventive recoater also comprises a powder deflector positioned to substantially uniformly intercept the powder curtain and deflect the powder it contains onto the substrate or powder bed surface.

In some embodiments, the inventive recoater includes one or more leveling devices, e.g., a roller, a doctor blade, et cetera, which are adapted to level out the powder that has been deflected onto the substrate or powder bed by the powder deflector. In some embodiments, the powder deflector and a leveling device are provided combined as a single component of the inventive recoater.

In some embodiments of the present invention, the conveyor belt is adapted to have a downwardly inclined section which controllably conveys the powder from the height at which it was received onto the conveyor belt from the powder reservoir to a lower height which is proximal to the powder bed or other substrate onto which the powder is to be deposited. The powder curtain emitted from the conveyor belt at this reduced height entrains much less of the surrounding air (or other ambient atmosphere) and has a reduced amount of kinetic energy, thus reducing or eliminating the amount of pluming of fine powders. A powder deflector may optionally be used to intercept the powder curtain and deflect the powder it contains onto the powder bed or other substrate so as to further reduce the amount of pluming.

In some embodiments of the present invention, a downwardly inclined chute is used instead of or in conjunction with a downwardly inclined section of the conveyor belt to controllably transport the powder to a lower height which is proximal to the powder bed or other substrate onto which the powder is to be deposited. A powder deflector may optionally be used to intercept the powder curtain emitted from the end of the chute and deflect the powder it contains onto the powder bed or other substrate so as to further reduce the amount of pluming.

The present invention also includes powder-layer three-dimensional printers which comprise a recoater such as described in the previous paragraphs of this invention summary section.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is a schematic perspective view of a powder-layer three-dimensional printer embodiment.

FIG. 2 is a schematic front perspective view of a recoater embodiment.

FIG. 3 is a schematic perspective cross-sectional view taken along cutting plane 3-3 of FIG. 2.

FIG. 4 is a schematic side cross-sectional view taken along cutting plane 3-3 of FIG. 2

FIG. 5 is a schematic side view of a recoater embodiment having a roller as a leveling device.

FIG. 6 is a schematic side view of a recoater embodiment having a doctor blade as a leveling device.

FIG. 7 is a schematic cross-sectional side view of a recoater embodiment having a shrouding enclosure.

FIG. 8 is a schematic perspective partial view of a recoater embodiment.

FIG. 9 is a schematic cross-sectional partial side view of a recoater embodiment wherein the conveyor belt is in operative communication with a side opening of the powder reservoir.

FIG. 10 is another schematic cross-sectional partial side view of a recoater embodiment wherein the conveyor belt is in operative communication with a side opening of the powder reservoir.

FIG. 11 is a schematic cross-sectional side view of a recoater embodiment having an angled blade-type powder deflector.

FIG. 12 is a schematic cross-sectional side view of a recoater embodiment having an arcuate powder deflector.

FIG. 13 is a schematic cross-sectional side view of a recoater embodiment having a powder deflector-leveler.

FIG. 14 is a schematic cross-sectional side view of a recoater embodiment having a conveyor belt having a downwardly inclined section.

FIG. 15 is a schematic cross-sectional side view of a recoater embodiment having a downwardly inclined chute.

### DESCRIPTION OF PREFERRED EMBODIMENTS

In this section, some preferred embodiments of the present invention are described in detail sufficient for one skilled in the art to practice the present invention without undue experimentation. It is to be understood, however, that the fact that a limited number of preferred embodiments are described herein does not in any way limit the scope of the present invention as set forth in the claims. It is to be understood that whenever a range of values is described herein or in the claims that the range includes the end points and every point therebetween as if each and every such point had been expressly described. Unless otherwise stated, the word “about” as used herein and in the claims is to be construed as meaning the normal measuring and/or fabrication limitations related to the value which the word “about” modifies. Unless expressly stated otherwise, the term “embodiment” is used herein to mean an embodiment of the present invention.

The recoaters of the present invention have particular utility with powder-layer three-dimensional printers. Although the recoaters may be used with any type of powder-layer three-dimensional printers, for the sake of conciseness, the only type of powder-layer three-dimensional printers that will be discussed in this section are those of the binder-jetting three-dimensional printer type. The binder-jetting three-dimensional printers are also sometimes in the art referred to as “three-dimensional inkjet printers” because the binder jetting is done using a print head that resembles those developed for inkjet printing. The basic binder jetting three-dimensional printing process was invented 1980's and developed in the 1990's at the Massachusetts Institute of Technology and is described in several United States patents, including the following U.S. Pat. No. 5,490,882 to Sachs et al., U.S. Pat. No. 5,490,962 to Cima et al., U.S. Pat. No. 5,518,680 to Cima et al., U.S. Pat. No. 5,660,621 to Bredt et al., U.S. Pat. No. 5,775,402 to Sachs et al., U.S. Pat. No. 5,807,437 to Sachs et al., U.S. Pat. No. 5,814,161 to Sachs et al., U.S. Pat. No. 5,851,465 to Bredt, U.S. Pat. No. 5,869,170 to Cima et al., U.S. Pat. No. 5,940,674 to Sachs et al., U.S. Pat. No. 6,036,777 to Sachs et al., U.S. Pat. No. 6,070,973 to Sachs et al., U.S. Pat. No. 6,109,332 to Sachs et al., U.S. Pat. No. 6,112,804 to Sachs et al., U.S. Pat. No. 6,139,574 to Vacanti et al., U.S. Pat. No. 6,146,567 to Sachs et al., U.S. Pat. No. 6,176,874 to Vacanti et al., U.S. Pat. No. 6,197,575 to Griffith et al., U.S. Pat. No. 6,280,771 to Monkhouse et al., U.S. Pat. No. 6,354,361 to Sachs et al., U.S. Pat. No. 6,397,722 to Sachs et al., U.S. Pat. No. 6,454,811 to Sherwood et al., U.S. Pat. No. 6,471,992 to Yoo et al., U.S. Pat. No. 6,508,980 to Sachs et al., U.S. Pat. No. 6,514,518 to Monkhouse et al., U.S. Pat. No. 6,530,958 to Cima et al., U.S. Pat. No. 6,596,224 to Sachs et al., U.S. Pat. No. 6,629,559 to Sachs et al., U.S. Pat. No. 6,945,638 to Teung et al., U.S. Pat. No. 7,077,334 to Sachs et al., U.S. Pat. No. 7,250,134 to Sachs et al., U.S. Pat. No. 7,276,252 to Payumo et al., U.S. Pat. No. 7,300,668 to Pryce et al., U.S. Pat. No. 7,815,826 to Serdy et al., U.S. Pat. No. 7,820,201 to Pryce et al., U.S. Pat. No. 7,875,290 to Payumo et al., U.S. Pat. No. 7,931,914 to Pryce et al., U.S. Pat. No. 8,088,415 to Wang et al., U.S. Pat. No. 8,211,226 to Bredt et al., and U.S. Pat. No. 8,465,777 to Wang et al.

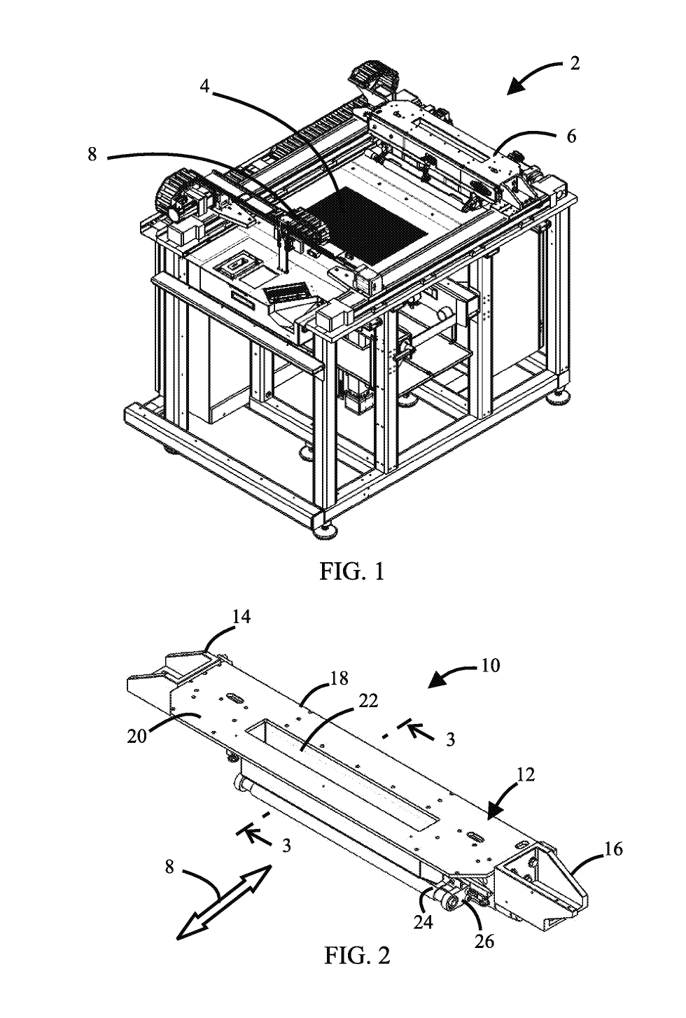

Referring to FIG. 1, there is shown a schematic perspective view of a powder-layer three-dimensional printer 2 embodiment. The printer 2 includes a powder bed 4 contained within a removable build box, a controllably movable recoater 6, and a controllably movable printing device 8. During the operation of the printer 2, after the recoater 6 has deposited one or more layers, the printing device 8 imparts the image of a slice of the article or articles which are to be printed by selectively printing a binder onto the uppermost deposited powder layer. The floor of the build box is indexed downward to receive each next layer deposited by the inventive recoater 6. The process of layer deposition and printing is continued until all of the desired article or articles have been printed.

FIG. 2 shows a schematic front perspective view of an embodiment of an inventive recoater, i.e., the recoater 10. The recoater 10 has a carriage 12 having first and second support ends 14, 16, which are adapted to movably support the recoater 10 upon a set of corresponding tracks (not shown). The carriage 12 also has a bridge section 18 extending between the first and second support ends 14, 16 and a top cover 20. The recoater 10 also has a powder reservoir 22 which is adapted to contain a build powder (not shown) which is selectively dispensed during the layer forming process. The recoater 10 is movable with respect to the powder bed or other substrate. The recoater 10 may be controllably moved by one or more drive mechanisms which are external to the recoater, integral to the recoater, or partially external and partially integral to the recoater. In some preferred embodiments, a drive mechanism is connected to one or both of the first and second supports 14, 16 to controllably move the recoater 10 in the directions indicated by arrow 8. The recoater 10 also has a conveyor belt 24 which is adapted to transport build powder from the reservoir 22 and dispense the build powder as a powder curtain. The conveyor belt 24 is controllably supported by a conveyor belt support system 26.

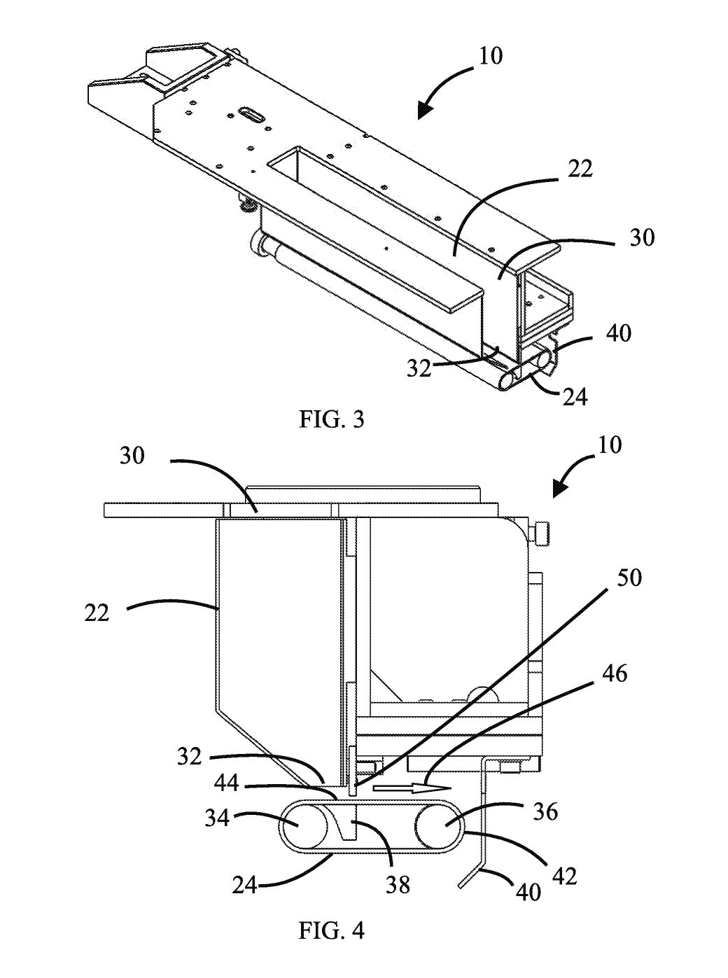

FIGS. 3 and 4 are, respectively, a schematic perspective cross-sectional view and a schematic side cross-sectional view, both taken along cutting plane 3-3 of FIG. 2. Referring now to these drawings, the reservoir 22 has a top opening 30 for receiving build powder and a bottom opening 32 for dispensing build powder. The bottom opening 32 is in operative communication with the conveyor belt 24, which is supported by the the conveyor belt support system 26 (see FIG. 2). The conveyor belt support system 26 comprises first and second rollers 34, 36, at least one of which is controllably driven by a motor system (not shown). The conveyor belt support system 26 also comprises a support table 38 which is positioned so as to ameliorate or eliminate sagging of the conveyor belt 24 under the weight of the build powder within the reservoir 22. Also visible in these drawings is a portion of a powder deflector 40 that is part of the recoater 10. The powder deflector 40 is fixedly or controllably spaced from the dispensing end 42 of the conveyor belt 24 and preferably extends at least the width of the conveyor belt 24 so as to intercept the powder curtain before it contacts the powder bed or other substrate. The bottom edge of the powder deflector 40 is sufficiently spaced above the powder bed or other substrate so that it does not scoop up or plow into the build powder that it is depositing. During operation of the recoater 10, as the recoater 10 traverses the powder bed or other substrate, the top side 44 of the conveyor belt 24 moves at a controlled speed to convey build powder from the reservoir 22 past a gate 50 in the direction indicated by the arrow 46 to form a powder curtain (not shown). The powder curtain impacts and is deflected by the powder deflector 40 onto the powder bed or other substrate. Without intending to be bound, the inventors believe that this deflection diminishes the impact energy the powder curtain imparts to an underlying powder bed and thereby reduces or eliminates disruption of the underlying powder bed that would otherwise be caused by the impact of the falling powder curtain. The gate 50 may be fixed but is preferably adjustable to control the gap between the bottom of the gate 50 and the top side 44 of the conveyor belt 24 so as to control the thickness of the powder layer being conveyed by the conveyor belt 24.

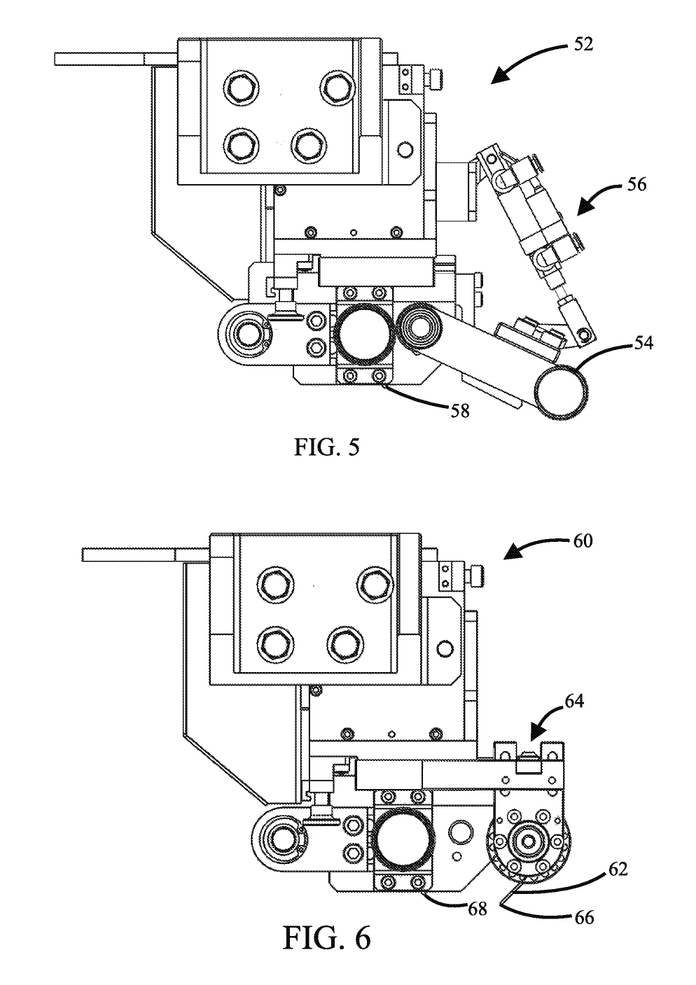

In some preferred embodiments, the recoater includes a leveling device. The leveling device may be any of the types that are known in art, and include, without limitation, doctor blades, rollers, the rotating blades described in U.S. Pat. No. 7,879,393 B2 to Ederer et al., and the powder spreaders described in U.S. Pat. No. 8,568,124 B2 to Brunermer. FIG. 5 shows an embodiment in which the recoater 52 includes a roller 54 as a leveling device. The roller 52 is a counter-rotating roller, but a roller may be used which is an idler roller or a roller that is driven to roll in the direction of travel of the recoater 52. The roller 54 includes a supporting drive and positioning mechanism 56 which permits the roller 54 to be controllably positioned and driven. Note that the bottom tip of the powder deflector 58 of the recoater 52 is just visible in the drawing.

FIG. 6 shows an embodiment of the recoater 60 which includes as a leveling device a doctor blade 62 which is selectively angularly positionable, i.e., the angle of the doctor blade 62 relative to the vertical is selectively controllable. The doctor blade 62 is mounted on a support and positioning mechanism 64 which permits the angle of the doctor blade 62 from the vertical to be selectively controlled. The profile of the working end 66 of the doctor blade 62 (or any doctor blade employed in an embodiment) may have any desired shape, e.g., square, rounded, knife-blade, et cetera. Note that some embodiments include doctor blades which are at a fixed angle relative to the vertical. The bottom tip of the powder deflector 68 of the recoater 60 is just visible in the drawing.

It is also to be understood that the height of the bottom of the leveling device above the powder bed or other substrate acts as a control of the thickness of the powder layer being formed by the recoater. Although the leveling device may be configured to be a fixed height above the powder bed or other substrate, it is preferable that the leveling device be configured so that this height is selectable.

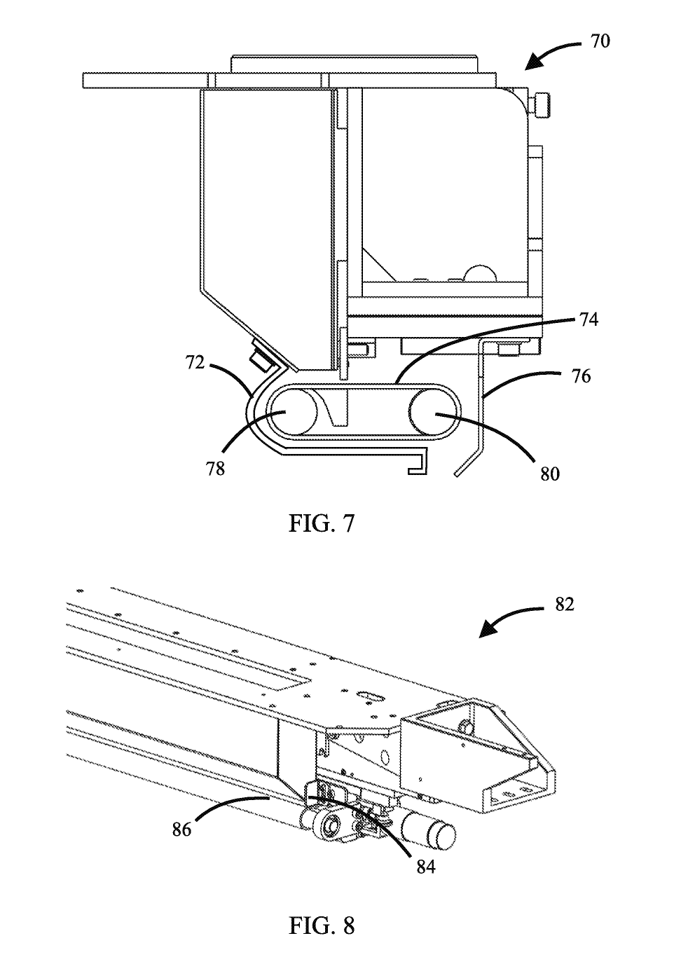

In some preferred embodiments, the recoater includes a shrouding enclosure adapted to at least partially contain a cloud or plume of fine build powder which may come into being as a result of the dispensing of build powder from the recoater onto a powder bed or other substrate. Referring to FIG. 7, there is shown a recoater 70 which is similar to the recoater 40 of FIG. 4 except it includes a shroud 72 which is positioned to enclose the space around the conveyor belt 74 and the space through which the powder curtain is formed and then deflected to an underlying powder bed or substrate by the powder deflector 76. Note that in this embodiment, the shroud 72 includes the powder deflector 76. Preferably, seals, such as vee-seals, are provided to seal around the rollers 78, 80 near their respective supporting ends where they extend through the shroud 72.

In some preferred embodiments, the recoater may include one or more features to aid in preventing the build powder from escaping from the powder reservoir in the vicinity of the conveyor belt. Referring to FIG. 8, there is shown a recoater 82, which is similar to the recoater 10 of FIG. 2, except that recoater 82 includes tabs, e.g. tab 84, positioned to prevent build powder from escaping from the powder reservoir near the conveyor belt 86.

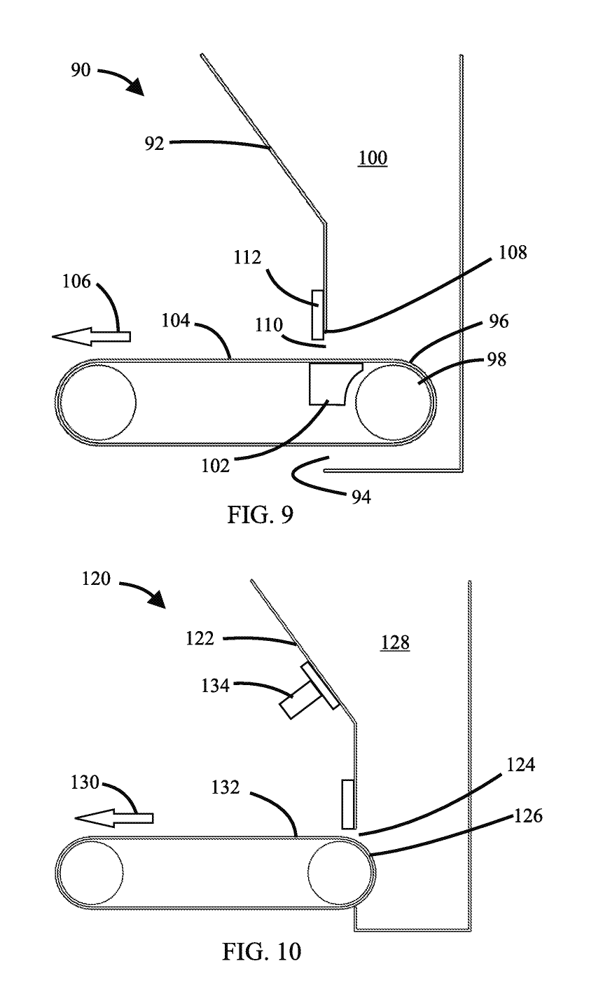

The embodiments described so far in this section have the conveyor belt in operative communication with the the powder reservoir of the recoater by way of an opening located at the bottom of the powder reservoir. In some embodiments, the conveyor belt is in operative communication with the powder reservoir by way of one or more openings in the side of the powder reservoir. FIGS. 9 and 10 illustrate two such embodiments. Referring to FIG. 9, there is shown a schematic cross-sectional view of a portion of a recoater 90 having a powder reservoir 92 having a side opening 94 and a conveyor belt 96. The conveyor belt 96 along with its supporting roller 98 are positioned within the cavity 100 of the powder reservoir 92 such that the build powder (not shown) contained within the cavity 100 is at least partially supported by the conveyor belt 96 and its support table 102. During operation of the recoater 90, the top side 104 of the conveyor belt 94 transports build powder from the cavity 100 in the direction indicated by arrow 106. The top edge 108 of the side opening 94 may act as a gating device to control the thickness of the powder layer exiting the cavity 100 on the conveyor belt 96. When this is the case, it is preferred that the height of the gap 110 between the conveyor belt top side 104 and the top edge 108 be adjustable by making the vertical position of the conveyor belt and/or the powder reservoir adjustable in relation to one another. In some embodiments, an adjustable gate, e.g., gate 112, is provided for the purpose of controlling the thickness of the powder layer exiting the cavity 100 on the conveyor belt 96.

Referring now to FIG. 10, there is shown a schematic cross-sectional view of a portion of a recoater 120 having a powder reservoir 122 having a side opening 124 and a conveyor belt 126. This configuration is similar to that shown in FIG. 9 except that the conveyor belt 126 is positioned so that it supports little, if any of the build powder (not shown) contained within the cavity 128 of the powder reservoir 122. The motion of the conveyor belt 126 during operation of the recoater 120 in the direction indicated by arrow 130 acts to collect build powder from the cavity 128 onto the top surface 132 of the conveyor belt 126. In embodiments having this configuration, it is preferable to include a vibrator, e.g. the vibrator 134, and/or some device within cavity 128, e.g. an augur or a paddlewheel, to agitate the build powder so as to ensure continuous contact of build powder with the conveyor belt 126 during the operation of the recoater 120. The thickness of the layer of build powder on the conveyor belt top surface 132 may be controlled in the manners described above with regard to FIG. 9.

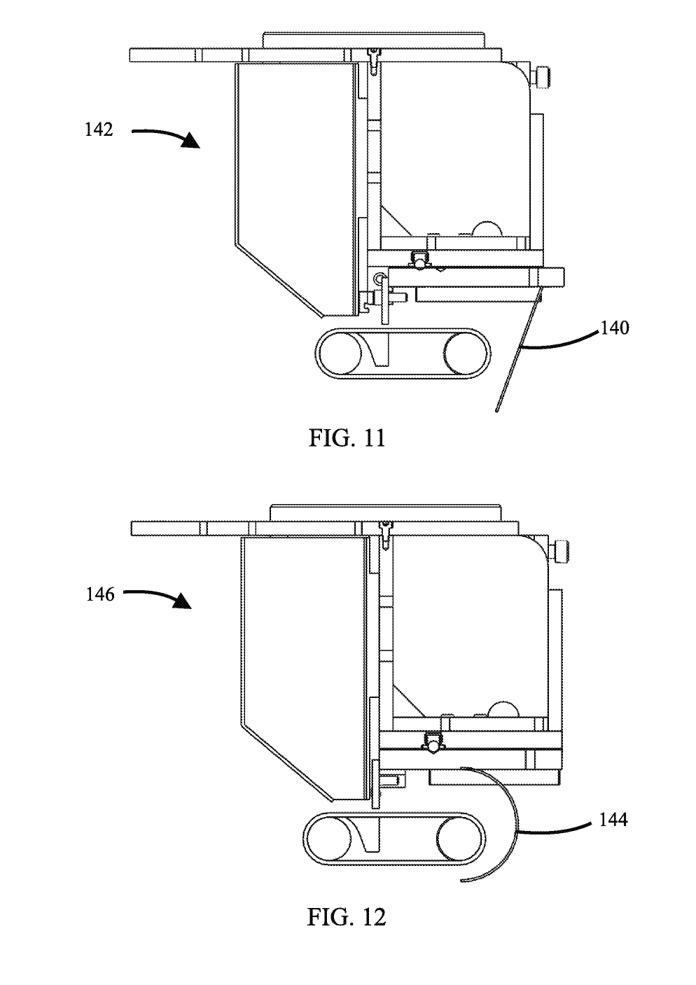

It is to be understood that, in embodiments, the powder deflector can take on any physical configuration so long as the powder deflector is capable of performing the function of deflecting the powder curtain emanating from the conveyor belt to the underlying powder bed or other substrate. Some such configurations of the powder deflectors are illustrated in FIGS. 11 and 12. The powder deflector 140 of the recoater 142 in FIG. 11 is configured as a straight blade which is oriented at an angle to the vertical. The powder deflector 144 of the recoater 146 in FIG. 12 is configured as an arcuate blade.

In some embodiments, a single component of the recoater is configured to perform the functions of a powder deflector and of a powder leveler. Such components are referred to hereinafter for convenience as a “powder deflector-leveler.” In embodiments, powder deflectors-levelers can take on any configuration so long as the device is capable of both deflecting the powder curtain as it emanates from the conveyor belt and leveling the layer of build powder that is deposited as a result of the deflection.

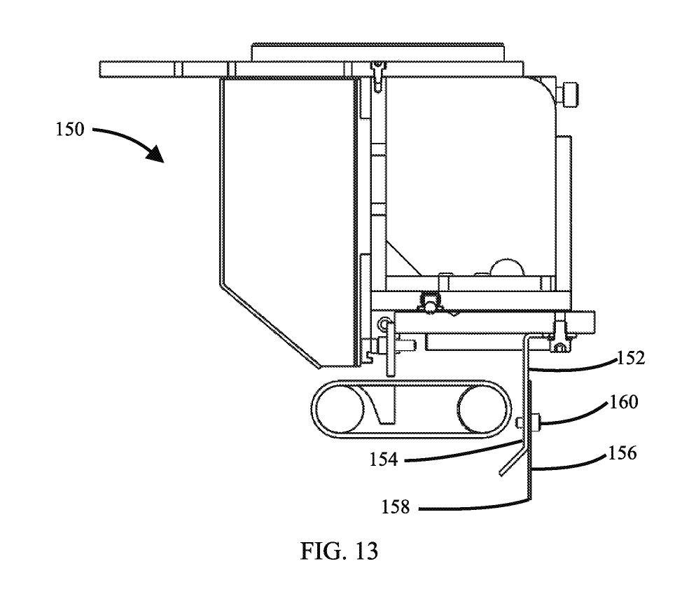

FIG. 13 shows a schematic cross-sectional side view of a recoater 150 having a powder deflector-leveler 152. The face 154 of the powder deflector-leveler 152 performs the function of the powder deflector as described above. The member 156 of the powder deflector-leveler 152 performs the leveling function of a leveler as described above. The height of the bottom edge 158 of the member 156 above an underlying powder bed or other substrate is manually adjustable by way of retaining bolt 160 which resides in a slot (not shown) in the member 156 which permits the member 156 to be vertically positionable with respect the rest of the powder deflector-leveler 152.

The deposition of fine powders is often accompanied by the problem of powder pluming. Powder pluming occurs when some or all of the powder particles being deposited have a terminal velocity which is less than the upward velocity component of a gas current or gas currents which are in the vicinity of where the powder is being deposited. Some embodiments are designed to reduce or eliminate powder pluming. Examples of some such embodiments will now be discussed.

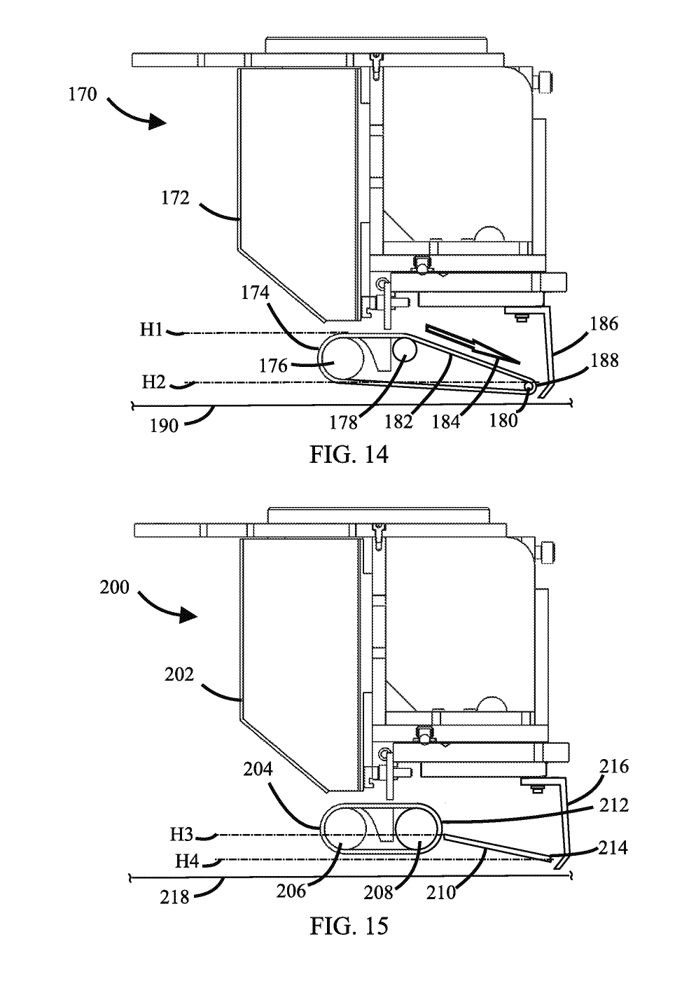

Referring now to FIG. 14, there is shown a schematic cross-sectional side view of a recoater embodiment which is designed to reduce or eliminate powder pluming. The recoater 170 has a powder reservoir 172 in operative communication with a conveyor belt 174, which is supported and controllably driven by a set of rollers consisting of drive rollers 176, 178, 180 at least one of which may be a drive roller. The conveyor belt 174 includes downwardly inclined section 182, which is adapted to controllably transport powder in the direction indicated by arrow 184. The powder is received by the conveyor belt 174 from the powder reservoir 172 at a height H1 and is controllably conveyed to a lower height 112. The recoater 170 also includes an optional powder deflector 186 which is spaced from the dispensing end 188 of the conveyor belt 174 so as to intercept and deflect a powder curtain (not shown) emanating from the dispensing end 188 before it contacts the powder bed 190.

Referring now to FIG. 15, there is shown schematic cross-sectional side view of another recoater embodiment which is designed to reduce or eliminate pluming. The recoater 200 has a powder reservoir 202 in operative communication with a conveyor belt 204. The conveyor belt 204 is supported and controllably driven by a set of rollers consisting of first and second rollers 206, 208, either or both of which can be a drive roller and one of which can be an idler roller. The recoater 200 also includes a downwardly inclined chute 210 which is positioned to intercept a powder curtain (not shown) emanating from the discharge end 212 of conveyor belt 204 and controllably downwardly convey the powder contained in the powder curtain from height 113 to lower height 114 and then discharge it as another powder curtain (not shown) at its end 214. The recoater 200 also includes an optional powder deflector 216 which is spaced from the chute end 214 so as to intercept and deflect the powder curtain emanating from it before the powder it contains contacts the powder bed 218.

The powder contacting surface of of the chute 210 may be configured to control the rate at which the powder slides across it, i.e., it surface may be flat or it may be corrugated or otherwise textured. Although the supporting structure for the chute 210 is not shown, it is to be understood that the supporting structure can adapted to fixedly or controllable set the downward inclination of the chute 210 and/or the proximity of the chute 210 to the conveyor belt 204.

Some embodiments having a downwardly inclined conveyor section have multiple downwardly conveyor sections. Some embodiments having an inclined chute have multiple downwardly inclined chutes.

It is to be understood that some embodiment recoaters which include a conveyor having a downwardly inclined section and/or a downwardly inclined chute may also include a powder leveling device and/or combination powder deflector/leveling device such as have been described above in this section. It is to be understood that included among the embodiments are three-dimensional printers which comprise a recoater having a downwardly inclined conveyor belt section and/or a downwardly inclined chute.

While only a few embodiments of the present invention have been shown and described, it will be obvious to those skilled in the art that many changes and modifications may be made thereunto without departing from the spirit and scope of the invention as described in the claims. All United States patents and patent applications, all foreign patents and patent applications, and all other documents identified herein are incorporated herein by reference as if set forth in full herein to the full extent permitted under the law.

What is claimed is:

1. A recoater comprising:
a movable carriage adapted to controllably traverse a substrate;
a powder reservoir;
a conveyor belt in operative communication with the powder reservoir; and
a powder deflector;
wherein the powder reservoir, the conveyor belt, and the powder deflector are carried by the carriage and the powder deflector is positioned to deflect a powder curtain emanating from the conveyor belt.

2. The recoater of claim 1 further including a leveling device.

3. The recoater of claim 1 further comprising an angularly adjustable doctor blade.

4. The recoater of claim 1 further comprising a counter-rotating roller.

5. The recoater of claim 1, wherein the powder reservoir has a bottom opening and the conveyor belt is in operative communication with the bottom opening.

6. The recoater of claim 1, wherein the powder reservoir has a side opening and the conveyor belt is in operative communication with the side opening.

7. The recoater of claim 1, wherein the powder deflector part of a component of the recoater which also includes a leveling device.

8. The recoater of claim 1, further including a gate adapted to control the thickness of a layer of a build powder on the conveyor belt.

9. The recoater of claim 1 further comprising a shroud enclosure adapted to at least partially contain a powder cloud resulting from the dispensing of powder by the recoater.

10. The recoater of claim 1 further comprising a support table proximal to the conveyor belt.

11. A three-dimensional printer comprising:
a recoater having
a movable carriage adapted to controllably traverse a substrate;
a powder reservoir;
a conveyor belt in operative communication with the powder reservoir; and
a powder deflector;
wherein the powder reservoir, the conveyor belt, and the powder deflector are carried by the carriage and the powder deflector is positioned to deflect a powder curtain emanating from the conveyor belt.

12. The recoater of claim 1 further including a leveling device.

13. The recoater of claim 1 further comprising an angularly adjustable doctor blade.

14. The recoater of claim 1 further comprising a counter-rotating roller.

15. The recoater of claim 1, wherein the powder reservoir has a bottom opening and the conveyor belt is in operative communication with the bottom opening.

16. The recoater of claim 1, wherein the powder reservoir has a side opening and the conveyor belt is in operative communication with the side opening.

17. The recoater of claim 1, wherein the powder deflector part of a component of the recoater which also includes a leveling device.

18. The recoater of claim 1, further including a gate adapted to control the thickness of a layer of a build powder on the conveyor belt.

19. The recoater of claim 1 further comprising a shroud enclosure adapted to at least partially contain a powder cloud resulting from the dispensing of powder by the recoater.

20. The recoater of claim 1 further comprising a support table proximal to the conveyor belt.

21. A recoater comprising:
a movable carriage adapted to controllably traverse a substrate;
a powder reservoir; and
a conveyor belt in operative communication with the powder reservoir, the conveyor belt having a downwardly inclined section;
wherein the powder reservoir and the conveyor belt are carried by the carriage.

22. The recoater of claim 21 further including a leveling device.

23. The recoater of claim 21 further comprising an angularly adjustable doctor blade.

24. The recoater of claim 21 further comprising a counter-rotating roller.

25. The recoater of claim 21, wherein the powder reservoir has a bottom opening and the conveyor belt is in operative communication with the bottom opening.

26. The recoater of claim 21, wherein the powder reservoir has a side opening and the conveyor belt is in operative communication with the side opening.

27. The recoater of claim 21, further including a gate adapted to control the thickness of a layer of a build powder on the conveyor belt.

28. The recoater of claim 21 further comprising a powder deflector, wherein the powder deflector is positioned to deflect a powder curtain emanating from the conveyor belt.

29. A recoater comprising:
a movable carriage adapted to controllably traverse a substrate;
a powder reservoir;
a conveyor belt in operative communication with the powder reservoir; and
a downwardly inclined chute positioned to receive a powder curtain emanating from the conveyor belt;
wherein the powder reservoir, the conveyor belt, and the chute are carried by the carriage.

30. The recoater of claim 29 further including a leveling device.

31. The recoater of claim 29 further comprising an angularly adjustable doctor blade.

32. The recoater of claim 29 further comprising a counter-rotating roller.

33. The recoater of claim 29, wherein the powder reservoir has a bottom opening and the conveyor belt is in operative communication with the bottom opening.

34. The recoater of claim 29, wherein the powder reservoir has a side opening and the conveyor belt is in operative communication with the side opening.

35. The recoater of claim 29, further including a gate adapted to control the thickness of a layer of a build powder on the conveyor belt.

36. The recoater of claim 29 further comprising a powder deflector, wherein the powder deflector is positioned to deflect a powder curtain emanating from the chute.

37. A three-dimensional printer comprising:
a recoater having
a movable carriage adapted to controllably traverse a substrate;
a powder reservoir; and
a conveyor belt in operative communication with the powder reservoir, the conveyor belt having a downwardly inclined section;
wherein the powder reservoir and the conveyor belt are carried by the carriage.

38. A three-dimensional printer comprising:
a recoater having
a movable carriage adapted to controllably traverse a substrate;
a powder reservoir;
a conveyor belt in operative communication with the powder reservoir; and
a downwardly inclined chute positioned to receive a powder curtain emanating from the conveyor belt;
wherein the powder reservoir, the conveyor belt, and the chute are carried by the carriage.
